(19) United States
(12) Patent Application Publication
(10) Pub. No.: US 2021/0380032 A1
(43) Pub. Date: Dec. 9, 2021

(54) PORTABLE CARGO STRAP STORAGE DEVICE

(71) Applicant: Sean Seymour, Dallas, TX (US)

(72) Inventor: Sean Seymour, Dallas, TX (US)

(21) Appl. No.: 17/338,415

(22) Filed: Jun. 3, 2021

Related U.S. Application Data
(60) Provisional application No. 63/036,515, filed on Jun. 9, 2020.

(51) Int. Cl. B60P 7/08

(52) U.S. Cl. CPC B60P 7/0846

(57) ABSTRACT

A portable cargo strap storage device comprising a hook receiving body having a series of holes for receiving hooks of cargo straps and a hook holding body for retaining the hooks of the cargo straps in the holes of the hook receiving body. A central hinge allows the device to be opened and closed to quickly and easily add or remove cargo straps. A spring keeps the hooks in place by keeping the device closed during storage and transport. The device allows straps to be quickly stored or retrieved and also prevents the straps from becoming entangled during storage.

### CROSS-REFERENCE TO RELATED APPLICATIONS

This application claims a benefit of priority under 35 U.S.C § 119 to Provisional Application No. 63/036515 filed on Jun. 9, 2020, which is fully incorporated herein by reference in its entirety.

### FIELD OF THE INVENTION

This disclosure relates generally to storage devices. More specifically, it relates to a storage and transport device for cargo tiedown straps.

### BACKGROUND

Cargo tiedown straps are frequently used to secure objects for transport, such as in the bed of a pickup truck or in a trailer. Cargo tiedown straps are usually comprised of a length of rope or webbing with a hook at each end. A tensioning device between the ends, such as a ratchet mechanism, allows the user to adjust the length of the cargo strap and tighten the strap to secure the cargo. Multiple cargo straps are often used to secure cargo, and when the straps are removed the straps are commonly placed in a pile or container such as a bucket, where are they become entangled. Detangling these straps takes a significant amount of time and causes frustration for the user.

Existing solutions for strap storage involve individually wrapping up each tiedown strap and securing it, such as with a rubber band or by placing each strap in an individual compartment of a storage container. Storing straps this way, however, can be time-consuming. Other storage solutions involve wall-mounted racks that the straps can be hung on. However, these racks are not portable and cannot be removed from the wall and placed in a vehicle for easy transport when needed.

It would therefore be advantageous to have a device which avoids these and other drawbacks of existing storage methods and devices.

### SUMMARY OF THE INVENTION

A portable cargo strap storage device according to embodiments may comprise a hook receiving body for receiving hooks of cargo straps and a hook holding body for retaining hooks of cargo straps. The hook receiving body may have a series of holes which a hook of a cargo strap may be placed into. The hook retaining body is designed to press against the hooks to retain them against the hook receiving body. The hook receiving body may comprise a series of holes for receiving the hooks of the cargo straps. The holes may have a circular, elliptical, or racetrack shape.

The hook receiving body and hook holding body may be biased toward each other to provide a force to retain the hooks. The hook receiving body and the hook holding body may be hinged and a torsion spring or compression spring used to create the biasing force. Such hinge may be comprised of hinge lobes on both the hook receiving body and the hook retaining body and a hinge pin which runs through a hole in the lobes. To facilitate opening and closing of the device, the hook receiving body and the hook holding body may also comprise a grip section.

### BRIEF DESCRIPTION OF THE DRAWING

FIG. 1 depicts a portable cargo strap storage device according to one embodiment.

### DETAILED DESCRIPTION

Cargo storage straps can easily become entangled when placed together. Detangling the straps take significant time. Individually wrapping each strap can prevent entanglement, but this also requires a significant amount time. The present invention provides a solution to these problems in the form of a portable cargo strap storage device that prevents cargo straps from becoming entangled yet requires very little time to store straps or remove them from storage.

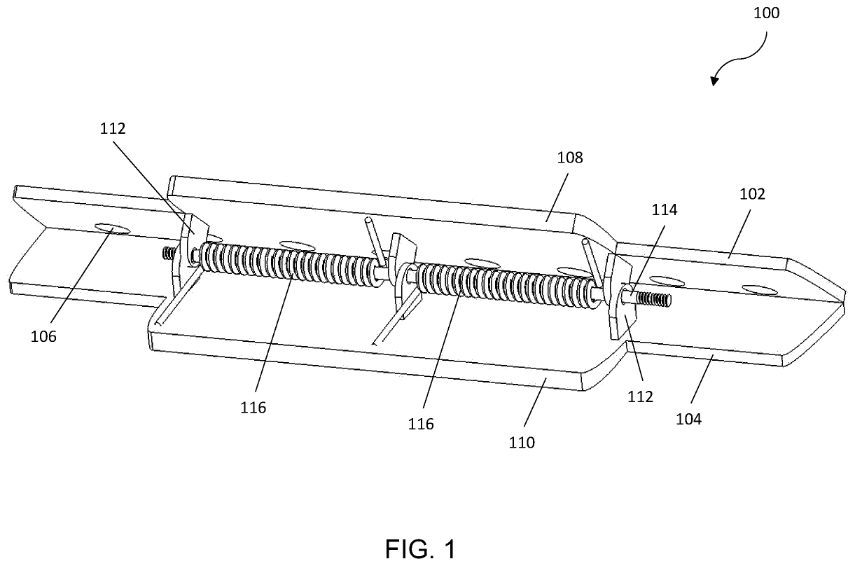

FIG. 1 depicts a portable cargo strap storage device 100 according to one embodiment. The device is comprised of a hook receiving body 102 and a hook holding body 104 which are hinged along the length and used to hold the hooked ends of one or more cargo straps. Hook receiving body 102 is a long, thin body having a series of holes 106 through the thickness of the body spaced along the length of the body near one edge of the hook receiving body 102. The holes 106 are designed to receive hooks of cargo straps. Grip section 108 of hook receiving body 102 defines the opposite edge of hook receiving body 102 (with respect to the width) and provides space for a user to grip the device.

Hook holding body 104 is also a long, thin body similar to a mirror image of hook receiving body 102. However, hook holding body 104 need not contain a series of holes and is designed to retain cargo strap hooks placed in the holes 106 by applying pressure to the hooks. Hook holding body 104 comprises a corresponding grip section 110, which together with grip section 108 provide a means for a user to both hold onto the device and open the device for insertion or removal of hooks. Both hook receiving body 102 and hook holding body 104 have a series of hinge lobes 112 spaced along the length of the body and placed roughly in the middle of the width of the bodies. The hinge lobes 112 are protrusions extending from the thickness of the hook receiving body 102 and hook holding body 104. Each hinge lobe 112 has a hole through the thickness of the lobe designed to accept hinge pin 114. Hinge pin 114 passes through all the holes in hinge lobes 112, creating a pivot along the axis of the hinge pin 114. Hinge pin 114 may have threaded ends for receiving a fastener such as a nut to secure the hinge pin in the device or the hinge pin may use a cotter pin or be bent or crimped. Hook receiving body 102 and hook holding body 104 rotate around the pivot created by hinge lobes 112 and hinge pin 114. Two torsion springs 116 provide a spring bias to hold the clamp closed, for example, by pushing the grip sections 108 and 110 apart, causing the hook holding body 104 to press against hooks inserted in the holes 106. The torsion springs 116 are retained by the hinge pin 114 passing through the center, as well as by being entrapped between hinge lobes 112. Hinge lobes 112 are longitudinally placed such that when assembled with the hinge pin, hook receiving body 102 and hook holding body 104 are restricted in axial movement. In other words, one set of hinge lobes has the opposite axial order then the other sets of hinge lobes.

To use the device to store a cargo strap, a user grips the device by placing his hand around grip section 108 and grip section 110. When the user squeezes grip section 108 and grip section 110, the squeezing force overcomes the spring force provided by torsion springs 116 and hook receiving body 102 and hook holding body 104 pivot around hinge pin 114, exposing holes 106 (“open”). The user may then place one or both hooked ends of the cargo strap through one or more holes 106 from the middle such that the end of the hook is pointing outward. When the user loosens his grip, the springs close the device and cause the hook holding body 104 to press against hooks placed through the holes 106 in hook receiving body 102. The springs thus serve to prevent the hooks from falling out of holes 106 during storage and transport. Because both ends of the strap may be retained in portable cargo strap storage device 100, there are no loose ends to become entangled. The device, along with the cargo straps stored therein may then be transported or placed in a container such as a bucket, tool bag, or toolbox for later use. Upon retrieving the device from the container, the straps remain untangled. To retrieve a strap, the user needs only to squeeze the device to open it, remove the hook ends from the hook receiving body, and release the clamp. Any additional straps in the device not removed stay retained in the device upon release.

It is contemplated that such a cargo strap storage device could take many forms without departing from the spirit of the invention. For example, the series of holes could take a number of shapes, such as circular, elliptical, racetrack, rectangular, square, or any other 2D shape. A hole may be sized to hold two or more cargo strap hooks. In the extreme case, a cargo strap storage device may comprise a single hole in the hook receiving body which is large enough to hold several cargo strap hooks.

A device may be hinged along the short edge instead of along the long edge. The device may also be designed such that the hook receiving body and hook holding body are formed as a single unit, such as by being formed of a continuous piece of sheet metal bent such that spring force is inherent in the finished piece, similar to a binder clip commonly used for securing pages of documents.

In yet another embodiment, the hook receiving body may not have any holes and may be configured such that a cargo strap hook can be accommodated around the hook receiving body. For example, the hook receiving body may comprise an elongated cylindrical bar with a diameter small enough to fit inside a cargo strap hook.

Other methods of securing cargo straps are contemplated. For example, instead of passing the open end of a cargo strap hook through a hole, a rod may be passed through the closed end of a cargo strap hook. A cap or plug on one or both ends of the rod may be used to retain the cargo straps on the rod by means of being larger than the closed end of the cargo strap hook. Yet another embodiment may take the form similar to a large safety pin which can retain a plurality of cargo straps.

The discussion herein of the present invention is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Herein, the terms “including,” “consisting of”, and “comprising” are used in an open-ended fashion, and thus should be interpreted to mean “including, but not limited to.” Also, the term “connect” or “connected” where used if at all is intended to mean either an indirect or direct connection. Thus, if a first component connects to a second component, that connection may be through a direct connection or through an indirect connection via other components and connections.

Certain terms are used throughout the description and claims to refer to particular system components and method steps. As one skilled in the art will appreciate, different companies may refer to a component by different names. This document does not intend to distinguish between components that differ in name but not function.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A portable cargo strap storage device, comprising:
a hook receiving body for receiving hooks of cargo straps; and
a hook holding body for retaining hooks of cargo straps.

2. The portable cargo strap storage device of claim 1, wherein the hook receiving body and the hook holding body are hinged.

3. The portable cargo strap storage device of claim 2, further comprising:
hinge lobes on the hook receiving body;
hinge lobes on the hook holding body; and
a hinge pin.

4. The portable cargo strap storage device of claim 3, further comprising:
a torsion spring.

5. The portable cargo strap storage device of claim 1, wherein the hook receiving body and hook holding body each comprise a grip section which facilitates opening and closing of the storage device by a user.

6. The portable cargo strap storage device of claim 4, wherein the hook receiving body comprises a series of holes for receiving hooks of cargo straps.

7. The portable cargo strap storage device of claim 4, wherein the series of holes are spaced along a length of the hook receiving body.

8. The portable cargo strap storage device of claim 7, wherein the holes have a circular shape.

9. The portable cargo strap storage device of claim 7, wherein the holes have an elliptical shape.

10. The portable cargo strap storage device of claim 7, wherein the holes have a racetrack shape.

11. A portable cargo strap storage device, comprising:
a hook receiving body for receiving hooks of cargo straps, the hook receiving body comprising a series of holes for receiving hooks of cargo straps; and
a hook holding body for retaining hooks of cargo straps.

12. The portable cargo strap storage device of claim 11, wherein the hook receiving body and the hook holding body are hinged.

13. The portable cargo strap storage device of claim 12, further comprising:
hinge lobes on the hook receiving body;
hinge lobes on the hook holding body; and
a hinge pin.

14. The portable cargo strap storage device of claim 13, further comprising:
a torsion spring.

15. The portable cargo strap storage device of claim 13, further comprising:
a compression spring.

16. The portable cargo strap storage device of claim 11, wherein the hook receiving body and hook holding body each comprise a grip section which facilitates opening and closing of the storage device by a user.

17. The portable cargo strap storage device of claim 13, wherein the series of holes are spaced along a length of the hook receiving body.

18. The portable cargo strap storage device of claim 17, wherein the holes have a circular shape.

19. The portable cargo strap storage device of claim 17, wherein the holes have an elliptical shape.

20. The portable cargo strap storage device of claim 17, wherein the holes have a racetrack shape.
